(19) United States
(12) Patent Application Publication
(10) Pub. No.: US 2008/0147704 A1
(43) Pub. Date: Jun. 19, 2008

(54) SYSTEMS AND METHODS FOR PROPAGATION OF DATABASE SCHEMA CHANGES

(76) Inventors: Debbie A. Godwin, Rogers, TX (US); Ricardo N. Olivieri, Austin, TX (US); Mark B. Whelan, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/609,921

(22) Filed: Dec. 13, 2006

(51) Int. Cl. G06F 7/00

(52) U.S. Cl. 707/102; 707/E17.044

(57) ABSTRACT

Systems, methods and media for propagation of database schema changes are provided. In one embodiment, a usability tool identifies changes in the schema of a database. The usability tool identifies source code dependencies that are affected by the changes in database schema. A tool informs a user of the affected dependencies and may also automatically update existing source code dependencies corresponding to the changed schema.

### FIELD

The present invention is in the field of computer databases. More particularly, the invention relates to propagation of database schema changes.

### BACKGROUND

Many different types of computing systems have attained widespread use around the world. These computing systems include personal computers, servers, mainframes and a wide variety of stand-alone and embedded computing devices. Sprawling client-server systems exist, with applications and information spread across many PC networks, mainframes and minicomputers. In a distributed system connected by networks, a user may access many application programs, databases, network systems, operating systems and mainframe applications. Computers provide individuals and businesses with a host of software applications including word processing, spreadsheet, and accounting. Further, networks enable high speed communication between people in diverse locations by way of e-mail, websites, instant messaging, and web-conferencing.

A common architecture for high performance, single-chip microprocessors is the reduced instruction set computer (RISC) architecture characterized by a small simplified set of frequently used instructions for rapid execution. Thus, in a RISC architecture, a complex instruction comprises a small set of simple instructions that are executed in steps very rapidly. These steps are performed in execution units adapted to execute specific simple instructions. In a superscalar architecture, these execution units typically comprise load/store units, integer Arithmetic/Logic Units, floating point Arithmetic/Logic Units, and Graphical Logic Units that operate in parallel. In a processor architecture, an operating system controls operation of the processor and components peripheral to the processor. Executable application programs are stored in a computer's hard drive. The computer's processor causes application programs to run in response to user inputs.

Computers are capable of storing and operating databases. A database may generaly be defined as a collection of records stored in a computer in a systematic way, so that a computer program can consult it to answer questions. The items retrieved in answer to queries become information that can be used to make decisions. The computer program used to manage and query a database is known as a database management system (DBMS). The properties and design of database systems are included in the study of information science. The central concept of a database is that of a collection of records, or pieces of knowledge. Typically, for a given database, there is a structural description of the type of facts held in that database: this description is known as a schema. The schema describes the objects that are represented in the database, and the relationships among them.

There are a number of different ways of organizing a schema, that is, of modeling the database structure: these are known as database models (or data models). The model in most common use today is the relational model, which in layman's terms represents all information in the form of multiple related tables each consisting of rows and columns. This model represents relationships by the use of values common to more than one table. Other models such as the hierarchical model and the network model use a more explicit representation of relationships.

SQL (Structured Query Language) is probably the most popular computer language used to create, modify, retrieve and manipulate data from relational database management systems. The language has evolved beyond its original purpose to support object-relational database management systems. SQL is defined by a standard developed by ANSI (American National Standards Institute) in 1986 and ISO (International Organization for Standardization) in 1987. SQL is designed for a specific, limited purpose—querying data contained in a relational database. Many variations and extensions of standard SQL are commercially available. SQL comprises keywords to perform certain query functions, for example data retrieval, data manipulation, data definition, and data control.

Maintaining source code that has dependencies on the structure of a database is a difficult acitivity when the database undergoes many changes. This situation is quite common in an environment where many developers each have an instance of the database and are each making changes to the database. Source code that depends on the structure of a database includes, but is not limited to, relational object oriented mapping files, SQL property files, and database replication configuration settings. Replication configuration settings specify what columns of what tables in the database (known as the source) are reproduced in another database instance, commonly known as the target. A software program uses the replication configuration settings to reproduce data from the source database in the target database. Thus, the source database comprises tables with rows and columns of data and some (or all) of this data is to be replicated to a target database. Once initial replication settings and dependencies are setup for source and target databases, any subsequent changes to the tables or columns of the source and target databases may affect replication settings and other dependencies. In the present state of the art, these changes must be tracked manually. When changes to a source database are completed, a replication tool (which is software) is used to specify the new replication settings and new dependencies. A problem is that the replication tool does not identify the changes that have been made to the structure of a database.

Thus, there is a need for a tool that identifies changes to a database and automatically updates source code dependencies, including replication settings.

### SUMMARY

The present invention provides systems, methods and media for updating dependencies on the schema of a database. One embodiment is a method for updating dependencies on changes in the schema of a database, comprising determining changes in the schema of a database. The schema comprises an organization of tables and columns of data. The method comprises determining dependencies affected by the change in schema. The dependencies comprise computer code references to at least some of the tables or columns. A user of the method is informed of the dependencies affected by the change in schema. The user may then modify the existing dependencies to form new dependencies corresponding to the change in schema of the database. The method may further comprise determining a new mapping of a data structure of the dependencies corresponding to the changes in the schema. The method may also comprise generating a new configuration file of dependencies in accordance with the new mapping. The method may yet further comprise storing the generated new configuration file in a dependency repository.

Embodiments include a system for updating dependencies on changes in the schema of a database. The system comprises a detection tool to detect changes in the schema of the database, the schema comprising an organization of tables and columns of data. The system further comprises a source code manager to determine dependencies affected by the change in schema, the dependencies comprising computer code references to at least some of the tables or columns. The system further comprises a user interface to inform a user of dependencies affected by the change in schema. The system may further comprise a source code identifier to identify a type of source code for which a dependency is affected by the change in schema. The system may also comprise a source code generator to generate new dependencies corresponding to the change in schema. A dependency repository may be provided to store the new dependencies.

Another embodiment of the invention provides a computer program product comprising instructions effective, when executing in a data processing system, to cause the system to perform a series of operations for updating source code dependencies in response to a change in schema of a database. The series of operations generally include determining changes in the schema of a database, the schema comprising an organization of tables and columns of data. The operations further comprise determining dependencies affected by the change in schema, the dependencies comprising computer code references to at least some of the tables or columns; and informing a user of the dependencies affected by the change in schema. The operations may further comprise determining a new mapping of a data structure of the dependencies corresponding to the changes in the schema and generating a new configuration file of dependencies in accordance with the new mapping. The generated new configuration file may be stored in a dependency repository.

### BRIEF DESCRIPTION OF THE DRAWINGS

Advantages of the invention will become apparent upon reading the following detailed description and upon reference to the accompanying drawings in which, like references may indicate similar elements:

FIG. 1 depicts an embodiment of a digital system within a network; the digital system comprises a usability tool and a repository for source code dependencies.

FIG. 2 depicts an embodiment of a usability tool for updating source code dependencies in response to a change in data base schema.

FIGS. 3 and 4 depict a flow chart of an embodiment for updating source code dependencies in response to changes in a database schema.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed description below is designed to render various embodiments obvious to a person of ordinary skill in the art.

Systems, methods and media for propagation of database schema changes are provided. In one embodiment, a usability tool identifies changes in the schema of a database. The usability tool identifies source code dependencies that are affected by the changes in database schema. A tool informs a user of the affected dependencies and may also automatically update the existing source code dependencies corresponding to the changed schema.

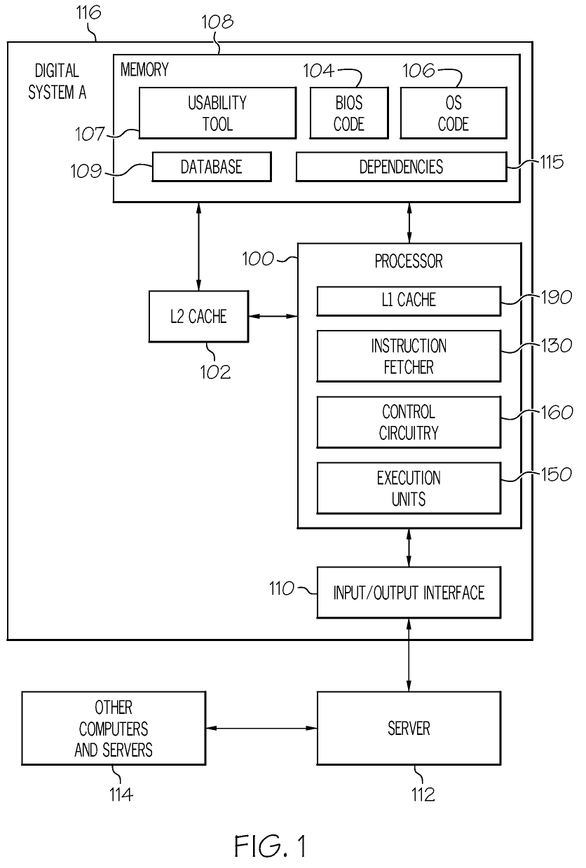

FIG. 1 shows a digital system 116 (herein sometimes referred to as a machine) such as a computer or server implemented according to one embodiment of the present invention. Digital system 116 comprises a processor 100 that can operate according to BIOS (Basis Input/Output System) Code 104 and Operating System (OS) Code 106. The BIOS and OS code is stored in memory 108. The BIOS code is typically stored on Read-Only Memory (ROM) and the OS code is typically stored on the hard drive of computer system 116. Digital system 116 comprises a level 2 (L2) cache 102 located physically close to processor 100. Memory 108 also stores other programs for execution by processor 100 and stores database software 109. Further, memory 108 also stores source code dependencies 115.

In an embodiment, memory 108 stores computer code 107 to update source code dependencies for the database 109. Usability tool 107 identifies changes made to the structure (schema) of database 109. Note that usability tool 107 may reside on the same computer as the database itself, or may reside on a different computer. The schema of a database may be viewed as the table and columns in which data of the database are organized. Usability tool 107 then identifies source code dependencies 115 that need to be updated as a consequence of the change in structure of the database. Source code dependencies comprise source code references to the data of tables and columns of the database. Once the changes to be made are identified, the user of usability tool 107 is given the option to either manually make the changes or to have the usability tool make the changes automatically. The usability tool updates software references to the tables/columns that were changed.

For example, suppose that changes to a DataBase 2 (DB2) program have been completed and saved. The usability tool knows the previous schema of the database, the current schema of the database resulting from the changes, and of any source code dependencies that exist for this database. Suppose that a new column is added to a table and two columns are deleted from the table. The user launches the usability tool 107. The usability tool connects to the database 109 and compares the current schema to the prior schema. Usability tool 107 informs the user that changes have occurred to the database and that those changes affect source code dependencies. Source code dependencies comprise computer code references to the tables and columns of the database. For example, a dependency may comprise a data structure mapping to a relational table, such as the mapping of an “Employee” data structure with elements such as social security number, employee number, etc. The elements correspond to columns of one or more tables of the database. Thus, for example, there may exist within the database a table named “employee” with columns labeled “employee number”, “date of hiring”, etc.

Usability tool 107 asks the user if it is OK to process the changes to the source code dependencies automatically, to which the user may answer yes. The user provides the location for each one of the source code dependencies. Usability tool 107 updates the dependencies by removing references to the two columns that were deleted. If, for instance, there is a replication settings dependency, the usability tool 107 also asks the user if the new column should be replicated, to which the user may answer yes. The tool updates the replication settings to include the new column. Once the source code dependencies are updated, the usability tool 107 asks if the current database schema is to be saved, to which the user may answer yes. Then the tool saves the current schema and the tool may be closed. These operations are performed by the processor 100 by executing computer code instructions. These instructions may be executed sequentially and in parallel.

Processor 100 comprises an on-chip level one (L1) cache 190, an instruction fetcher 130, control circuitry 160, and execution units 150. Level 1 cache 190 receives and stores instructions that are near to time of execution. Instruction fetcher 130 fetches instructions from memory. Execution units 150 perform the operations called for by the instructions. Execution units 150 may comprise load/store units, integer Arithmetic/Logic Units, floating point Arithmetic/Logic Units, and Graphical Logic Units. Each execution unit comprises stages to perform steps in the execution of the instructions fetched by instruction fetcher 130. In a superscalar architecture, different execution units operate in parallel. Thus, execution units 150 comprise a set of units of different types operating in parallel to execute instructions to make changes to the source code dependencies 115 in response to changes of the schema of the database 109.

Control circuitry 160 controls instruction fetcher 130 and execution units 150. Control circuitry 160 also receives information relevant to control decisions from execution units 150. For example, control circuitry 160 is notified in the event of a data cache miss in the execution pipeline to process a stall.

Digital system 116 also typically includes other components and subsystems not shown, such as: a Trusted Platform Module, memory controllers, random access memory (RAM), peripheral drivers, a system monitor, a keyboard, a color video monitor, one or more flexible diskette drives, one or more removable non-volatile media drives such as a fixed disk hard drive, CD and DVD drives, a pointing device such as a mouse, and a network interface adapter, etc.

Digital systems 116 may include personal computers, workstations, servers, mainframe computers, notebook or laptop computers, desktop computers, or the like. Processor 100 may also communicate with a server 112 by way of Input/Output Device 110. Server 112 connects system 116 with other computers and servers 114. Thus, digital system 116 may be in a network of computers such as the Internet and/or a LAN. Further, server 112 may control access to other memory comprising tape drive storage, hard disk arrays, RAM, ROM, etc.

Thus, in one mode of operation of digital system 116, the L2 cache receives from memory 108 data and instructions expected to be processed in the processor pipeline of processor 100. L2 cache 102 is fast memory located physically close to processor 100 to achieve greater speed. The L2 cache receives from memory 108 the instructions for a plurality of instruction threads. Such instructions may include load and store instructions, branch instructions, arithmetic logic instructions, floating point instructions, etc. The L1 cache 190 is located in the processor and contains data and instructions preferably received from L2 cache 102. Ideally, as the time approaches for a program instruction to be executed, the instruction is passed with its data, if any, first to the L2 cache, and then as execution time is near imminent, to the L1 cache.

Execution units 150 execute the instructions received from the L1 cache 190. Each of the units of execution units 150 may be adapted to execute a specific set of instructions. Instructions can be submitted to different execution units for execution in parallel. Data processed by execution units 150 are storable in and accessible from integer register files and floating point register files (not shown.) Data stored in these register files can also come from or be transferred to on-board L1 cache 190 or an external cache or memory. The processor can load data from memory, such as L1 cache, to a register of the processor by executing a load instruction. The processor can store data into memory from a register by executing a store instruction.

A digital system 116 will have its own memory for storing its operating system, BIOS, and the code for executing application programs, as well as files and data. The memory of a computer comprises Read-Only-Memory (ROM), cache memory implemented in DRAM and SRAM, a hard disk drive, CD drives and DVD drives. A server also has its own memory and may control access to other memory such as tape drives and hard disk arrays. Each computer may store and execute its own application programs. Some application programs, such as databases, may reside in the server. Thus, each computer may access the same database stored in a server. In addition, each computer may access other memory by way of a server.

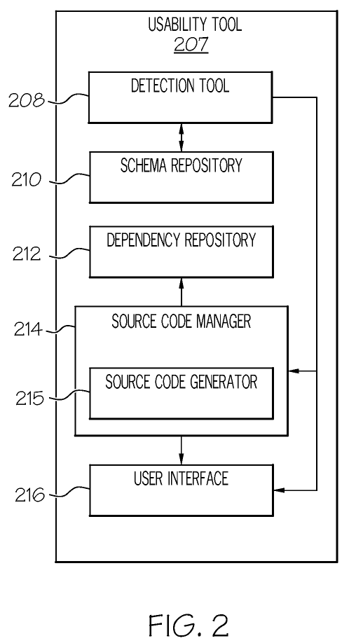

FIG. 2 shows a block diagram of an embodiment of a usability tool 207 as described herein. The functions of usability tool 207 are effectuated by processor 100 operating in response to computer code instructions. In the embodiment of FIG. 2, usability tool 207 comprises a detection tool 208, a schema repository 210, a software dependency repository 212 a source code manager 214, and a user interface 216.

Detection tool 208 is a sub-component that identifies changes to the database structure. Thus, detection tool 208 compares the current schema of the database to the previous schema stored in schema repository 210. For example, a column may be added or deleted from a table, and a new table may be added, or an old table may be deleted. In one embodiment, detection tool 208 is quite easily implemented using the Java computer language.

Schema repository 210 stores the schema for the database. The schema of the database can be thought of as a catalog that describes each one of the objects contained in the database such as tables, columns, an order of definition of the columns, constraints, triggers, views, etc. Thus, the schema of a database comprises tables and columns in which data resides. Schema repository 210 may be a database or a set of one or more XML files or both.

Source code dependency repository 212 contains a list of the dependencies between source code of an application program and the database. For example, a source code dependency may be software language references to one or more tables or table columns in the database or replication configuration settings. For example, if an application program uses a relational object oriented mapping framework such as Hibernate, then this application has a “Hibernate” source code dependency. In such a case, this dependency is listed in the dependency repository 212.Dependency repository 212 may be a database or XML files or both.

Source code manager 214 comprises a set of one or more modules that each understands the composition of a source code type in order to create and update software references to elements of the database. For example, a source code manager may recognize source code for the relational object mapping tool of Hibernate.

Source code manager 214 is informed of changes in the database schema detected by detection tool 208. With this information, source code manager 214 determines if changes to the database structure require a change in the source code referring to the structure. Thus, source code manager 214 will identify dependencies that are affected by a change in the database schema. In one embodiment, the user of the usability tool is prompted to make the changes. In another embodiment, the user is prompted to allow the source code manager to automatically make the required changes. Accordingly, source code manager 214 comprises a source code generator 215 to generate new source code and update existing source code according to the change in schema.

The usability tool 207 also comprises a user interface 216. User interface 216 provides an interactive graphical display on a video monitor of changes to the schema as well as a display of dependencies affected by the change in schema. In some embodiments, user interface 216 also displays source code automatically generated by source code manager 214. In this embodiment, the user may be given an option to accept or edit the changes automatically generated by source code manager 214.

Thus, embodiments comprise a system for updating dependencies on changes in the schema of a database. The system comprises a detection tool to detect changes in the schema of the database, the schema comprising an organization of tables and columns of data. The system also comprises a source code manager to determine dependencies affected by the change in schema, the dependencies comprising computer code references to at least some of the tables or columns. A user interface is provided to inform a user of dependencies affected by the change in schema. The source code manager may comprise a source code generator to generate new source code and update existing source code corresponding to the change in schema.

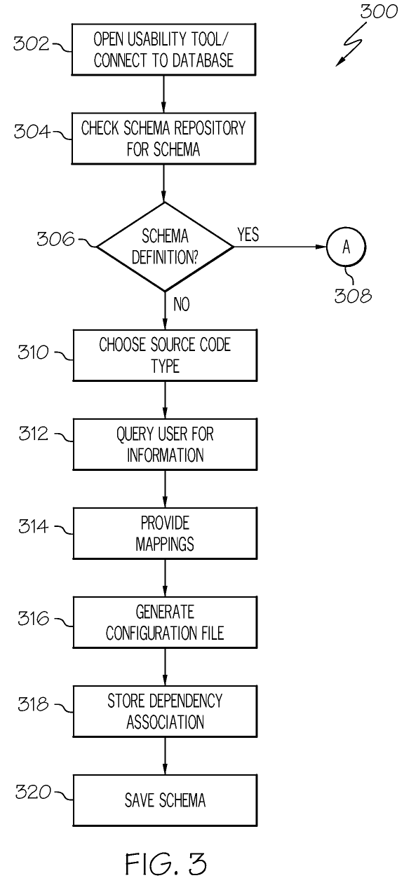

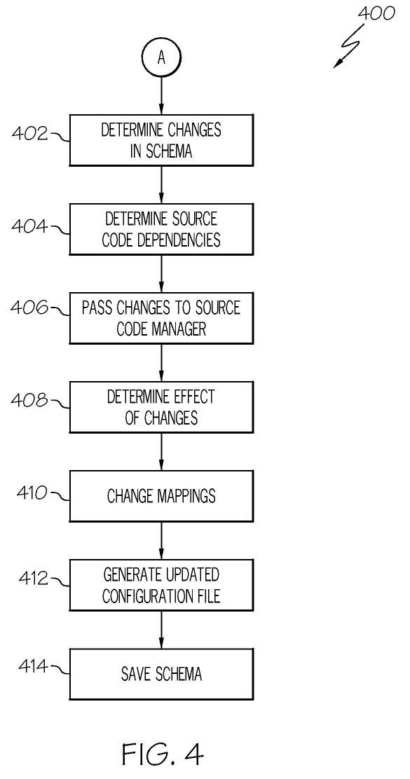

FIG. 3 shows a flow chart 300 of an embodiment of a process for updating source code dependencies according to the methods described herein. First, the user opens the usability tool. The usability tool establishes communication with the database (element 302). The detection tool of the usability tool checks to determine if there is a pre-existing schema for the database (element 304). If there is a pre-existing schema (element 306) the process moves to element 308, which leads to the flow chart of FIG. 4. If there is not a pre-existing schema (element 306)—which will be the case if the database is newly created—then the process proceeds to element 310, wherein the user is given the option of choosing a source code type. In some embodiments, the source code type may be identified automatically by the source code managers. In such cases, the user must provide a location where the source code is stored. Each of the source code managers will then traverse the location looking for source code they understand.

The source code type will depend on the software application program that utilizes the database. For example, Hibernate is a relational object mapping tool. Thus, for this example the user could choose “Hibernate configuration file” as the source code type. The usability tool will then query the Hibernate source code manager to determine what information the user must provide to generate a Hibernate configuration file [this is the source code] and will query the user for this information (element 312).

In the embodiment of FIG. 3, the user will then provide a mapping between a data structure(s) and the table(s) of the database. That is, each property or component of a data structure will correspond to a column or table of the database and the user specifies the correspondence (element 314). Note that is some embodiments, the user provides relationship metadata instead, wherein the metadata establishes the relationship between the database schema and the source code to be generated. Once the user has completed this task, the usability tool passes the mapping information to the source code manager of the usability tool, which then generates the configuration file (element 316) based on the user-supplied mappings. The usability tool stores in the dependency repository (element 318) an entry that states that the there is a “Hibernate configuration file” dependency. Finally, the usability tool saves the established schema in the schema repository (element 320) and the user closes the usability tool

Assume now, that the database is subsequently changed. For example, suppose that since saving the original schema, one table was added, one table was deleted, and one table was modified. The table that was modified has a new column added and an old column is deleted. As discussed with reference to FIG. 3, the user opens the usability tool and connects to the database (element 302). The usability tool then determines if a previous schema exists (element 304). If a schema definition exists, (element 306), the process proceeds to element 402 of FIG. 4. The detection tool of the usability tool determines what changes have been made to the pre-existing schema (element 402). Note that in some embodiments the usability tool can be used to generate new source code even if the schema is not changed.

The usability tool then queries the dependency repository to determine the source code dependencies that are affected by the changes in the schema of the database (element 404). For the present example, the usability tool will determine that there is a “Hibernate configuration file” dependency. The usability tool will then pass the detected schema changes to the source code manager for Hibernate source code (element 406). The source code manager detects the effect of the schema changes upon the Hibernate source code (element 408). In one embodiment the user is asked to provide a path name to the Hibernate configuration file and is given the option to choose automatic updating of this file. In another embodiment, the location of the Hibernate configuration file is kept in the source code dependency repository, which the user has the option to update.

In the embodiment of FIG. 4, the Hibernate source code manager will change the mappings according to the schema changes determined by the usability tool (element 410). For example, the source code manager will remove the mappings for the table that was deleted. Further, the source code manager will prompt the user to provide new mappings for the table that was added and for the column that was added to the modified table. A mapping establishes a correspondence between the elements of a data structure and the columns of tables in the database. In some embodiments, metadata is provided instead, wherein the metadata provides the relationship between the database schema and the code to be generated. Finally, the source code will remove the mappings for the column that was deleted from a table. The Hibernate source code manager of the usability tool then updates the Hibernate configuration file (element 412). Finally, the new schema is saved in the schema repository (element 414) and the user closes the usability tool.

Thus, some embodiments comprise a method for updating dependencies on changes in the schema of a database. The method comprises determining changes in the schema of a database, the schema comprising an organization of tables and columns of data. The method also comprises determining dependencies affected by the change in schema, the dependencies comprising computer code references to at least some of the tables or columns. According to one embodiment the user is informed of the dependencies affected by the change in schema. In some embodiments the method comprises determining a new mapping of a data structure of the dependencies corresponding to the changes in the schema. A new configuration file is generated containing new dependencies in accordance with the new mapping. The dependencies that exist are stored in the dependency repository.

The invention can take the form of an entirely hardware embodiment, an entirely software embodiment or an embodiment containing both hardware and software elements. In one embodiment, the invention is implemented in software, which includes but is not limited to firmware, resident software, microcode, etc. Furthermore, embodiments can take the form of a computer program product accessible from a machine accessible readable medium providing program code for use by or in connection with a computer such as shown in FIG. 1, or any instruction execution system.

For the purposes of this description, a machine accessible or computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a machine accessible medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory 108 employed during actual execution of the program code, bulk storage, and cache memories 102, 190, which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Thus, another embodiment of the invention provides a computer program product containing instructions effective, when executing in a data processing system, to cause the system to perform a series of operations for determining changes in the schema of a database, the schema comprising an organization of tables and columns of data. The operations also comprise determining dependencies affected by the change in schema, the dependencies comprising computer code references to at least some of the tables or columns; and informing a user of the dependencies affected by the change in schema.

The series of operations caused to be performed by the computer program product may also comprise determining a new mapping of a data structure of the dependencies corresponding to the changes in the schema. The operations may also comprise generating a new configuration file of dependencies in accordance with the new mapping. The generated new configuration file may be stored in a dependency repository. Also, the operations may comprise determining which columns and tables of the database schema are to be replicated.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for updating dependencies on changes in the schema of a database, comprising:
determining changes in the schema of a database, the schema comprising an organization of tables and columns of data;
determining dependencies affected by the change in schema, the dependencies comprising computer code references to at least some of the tables or columns; and
informing a user of the dependencies affected by the change in schema.

2. The method of claim 1, further comprising determining a new mapping of a data structure of the dependencies corresponding to the changes in the schema.

3. The method of claim 2, further comprising generating a new configuration file of dependencies in accordance with the new mapping.

4. The method of claim 3, further comprising storing a list of new dependencies in a dependency repository.

5. The method of claim 1, further comprising storing a location of source code corresponding to the dependencies.

6. The method of claim 1, further comprising storing metadata indicative of the dependencies.

7. The method of claim 1, further comprising determining which columns and tables of the database schema are to be replicated.

8. The method of claim 1, wherein determining changes in the schema comprises comparing a new schema to a pre-existing schema that is stored in a schema repository.

9. A system for updating dependencies on changes in the schema of a database, comprising:
a detection tool to detect changes in the schema of the database, the schema comprising an organization of tables and columns of data;
a source code manager to determine dependencies affected by the change in schema, the dependencies comprising computer code references to at least some of the tables or columns; and
a user interface to inform a user of dependencies affected by the change in schema.

10. The system of claim 9, wherein the source code manager further comprises a source code generator to generate new source code and update existing source code dependencies corresponding to the change in schema.

11. The system of claim 11, further comprising a dependency repository to store the dependencies that exist.

12. The system of claim 9, further comprising a schema repository to store the current schema of the database.

13. The system of claim 9, wherein the detection tool determines a change in schema by comparing a current schema to a pre-existing schema stored in a schema repository.

14. A computer program product comprising a computer useable medium having a computer readable program, wherein the computer readable program when executed on a computer causes the computer to:
determine changes in the schema of a database, the schema comprising an organization of tables and columns of data;
determine dependencies affected by the change in schema, the dependencies comprising computer code references to at least some of the tables or columns; and
inform a user of the dependencies affected by the change in schema.

15. The computer program product of claim 14, further comprising determining a new mapping of a data structure of the dependencies corresponding to the changes in the schema.

16. The computer program product of claim 15, further comprising generating a new configuration file of dependencies in accordance with the new mapping.

17. The computer program product of claim 16, further comprising storing the generated new configuration file in a dependency repository.

18. The computer program product of claim 14, further comprising storing a location of source code corresponding to the dependencies.

19. The computer program product of claim 14, further comprising determining which columns and tables of the database schema are to be replicated.

20. The computer program product of claim 14, wherein determining changes in the schema comprises comparing a new schema to a pre-existing schema that is stored in a schema repository.
